(19) United States
(12) Patent Application Publication
(10) Pub. No.: US 2011/0175988 A1
(43) Pub. Date: Jul. 21, 2011

(54) 3D VIDEO GRAPHICS OVERLAY

(75) Inventors: Ajay K. Luthra, San Diego, CA (US); Jae Hoon Kim, San Diego, CA (US); Arjun Ramamurthy, San Diego, CA (US); Haifeng Xu, San Diego, CA (US)

(73) Assignee: GENERAL INSTRUMENT CORPORATION, Horsham, PA (US)

(21) Appl. No.: 13/011,549

(22) Filed: Jan. 21, 2011

Related U.S. Application Data
(60) Provisional application No. 61/297,132, filed on Jan. 21, 2010.

(51) Int. Cl. H04N 13/04

(52) U.S. Cl. 348/51; 348/E13.075

(57) ABSTRACT

Preparing a three dimensional (3D) video graphical overlay based on a two dimensional (2D) graphical image in a decoded stereoscopic video signal. This includes receiving the 2D graphical image and receiving 3D information associated with the 3D video graphical overlay. This also includes reproducing, using a processor, the 2D graphical image to form a first view graphical image and a second view graphical image in a graphics window. This also includes mapping the first and second view graphical images, using the 3D information, to frames in the 3D video to form a 3D video graphical overlay of a 3D video stream. This also includes blending the 3D video graphical overlay and the 3D video stream.

### CLAIM FOR PRIORITY

The present application claims the benefit of priority to U.S. Provisional Patent Application Ser. No. 61/297,132, filed on Jan. 21, 2010, entitled “Graphics Overlay for 3DTV”, by Ajay K. Luthra, et al., the disclosure of which is hereby incorporated by reference in its entirety.

### BACKGROUND

Depth perception for three dimensional (3D) video, also called stereoscopic video, is often provided through video compression by capturing two related but different views, one for the left eye and another for the right eye. The two views are compressed in an encoding process and sent over various networks or stored on storage media. A decoder for compressed 3D video decodes the two views and then outputs the decoded 3D video for presentation. A variety of formats are used to encode, decode and present the two views. The various formats are utilized for different reasons and may be placed into two broad categories. In one category, the two views for each eye are kept separate with a full resolution of both views transmitted and presented for viewing. In the second category, the views are merged together into a single video frame using techniques, also known as resolution methods, such as a checker board pattern, left and right panels, and top and bottom panels.

In both categories, the graphical images, including objects such as “on screen display” (OSD) and “closed caption data (CCD),” or picture in picture (PIP) video, which are associated with the 3D video, are not displayed properly on stereoscopic videos as they appear in both eyes. There is no established standard which addresses incorporating additional data for graphics in 3D video, such as OSD or CCD, in order for the graphics to be stereoscopically displayed in the 3D video presented in 3D television (3DTV). Furthermore, even existing standards, such as CEA 708 for CCD, do not address all the different types of graphical objects generated and displayed on two dimensional (2D) television displays. Furthermore, existing standards are dependent on putting in place new infrastructure to send new data for graphical objects to be displayed on 2D and 3D televisions.

### BRIEF DESCRIPTION OF THE DRAWINGS

Features of the present disclosure will become apparent to those skilled in the art from the following description with reference to the figures, in which:

FIG. 1 is a block diagram illustrating an apparatus, according to an example of the present disclosure;

FIG. 2A is a flow diagram illustrating a graphics overlay architecture operable with the apparatus shown in FIG. 1, according to an example of the present disclosure;

FIG. 2B is a flow diagram illustrating scaling and reproducing aspects of the graphics overlay architecture shown in FIG. 2A, according to an example of the present disclosure;

FIG. 2C is a flow diagram illustrating shifting, cropping and scaling aspects of the graphics overlay architecture shown in FIG. 2A, according to an example of the present disclosure;

FIG. 2D is a flow diagram illustrating scaling, reproducing and shifting aspects of the graphics overlay architecture shown in FIG. 2A, according to an example of the present disclosure;

FIG. 2E is a flow diagram illustrating scaling, reproducing and shifting aspects of the graphics overlay architecture shown in FIG. 2A, according to an example of the present disclosure;

FIG. 2F is a flow diagram illustrating a de-interlacing aspect of the graphics overlay architecture shown in FIG. 2A, according to an example of the present disclosure;

FIG. 3A is a flow diagram illustrating a picture in graphics architecture operable with the apparatus shown in FIG. 1, according to an example of the present disclosure;

FIG. 3B is a block diagram illustrating a display aspect of the picture in graphics architecture operable with the apparatus shown in FIG. 1, according to an example of the present disclosure;

FIG. 3C is a block diagram illustrating an Z-ordering aspect of the picture in graphics architecture operable with the apparatus shown in FIG. 1, according to an example of the present disclosure;

FIG. 4 is a flowchart illustrating a method, according to an example of the present disclosure;

FIG. 5 is a flowchart illustrating a more detailed method than the method shown in FIG. 4, according to an example of the present disclosure; and

FIG. 6 is a block diagram illustrating a computer system to provide a platform for the apparatus shown in FIG. 1, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It is readily apparent however, that the present disclosure may be practiced without limitation to these specific details. In other instances, some methods and structures have not been described in detail so as not to unnecessarily obscure the present disclosure. Furthermore, different examples are described below. The examples may be used or performed together in different combinations. As used herein, the term “includes” means includes but not limited to the term “including”. The term “based on” means based at least in part on.

This disclosure provides a method, apparatus and computer-readable medium for preparing and mapping 3D graphical images, including objects and/or video as a 3D graphical overlay for 3D video, such as appears in 3DTV. The disclosure presents a solution for processing and displaying the 3D graphical images without requiring any additional meta-data information to be packaged in the compressed 3D video stream. Hence a 3D graphical overlay 3D video may be implemented in set top boxes, integrated receiving devices or other devices associated with receiving a 3D video signal.

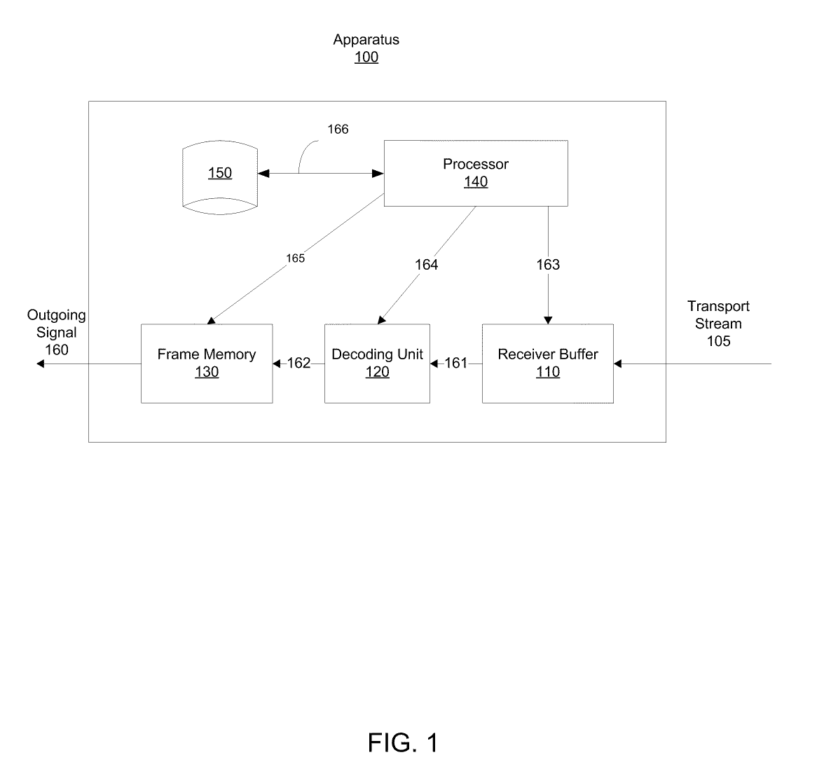

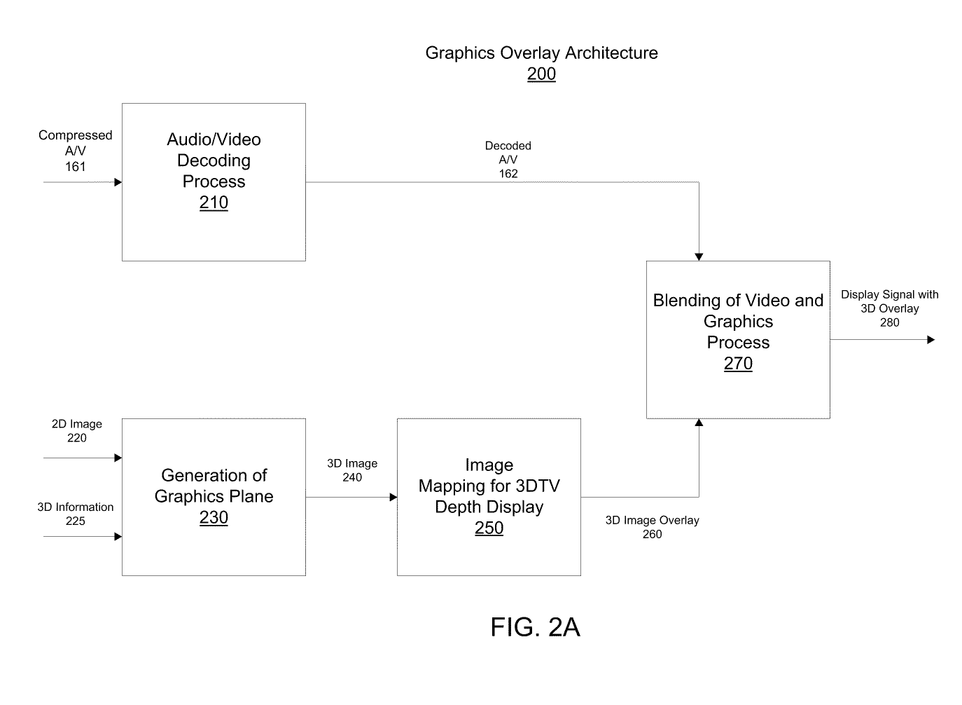

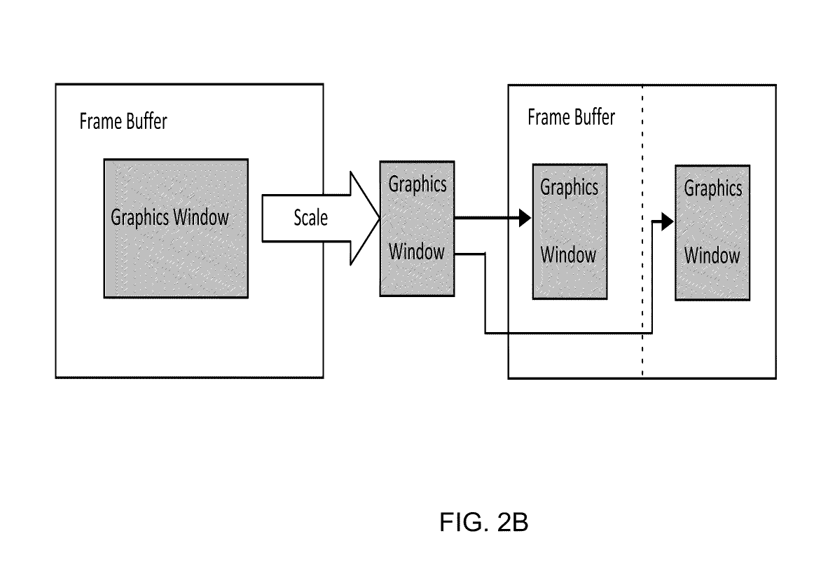

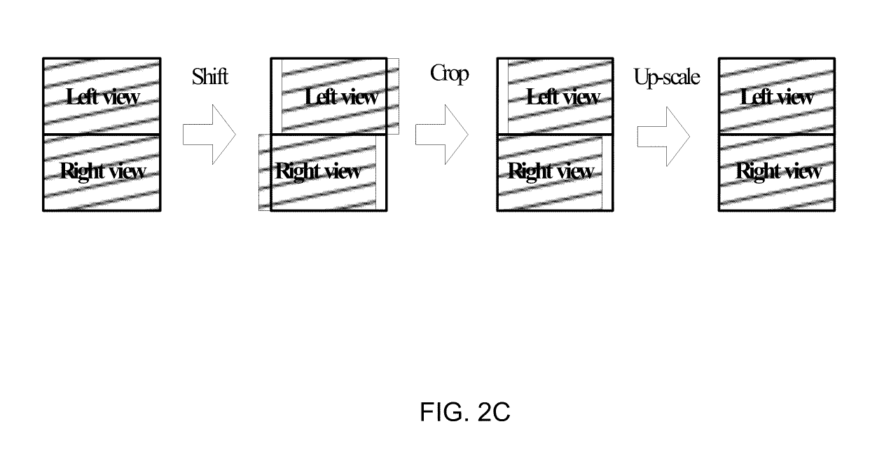

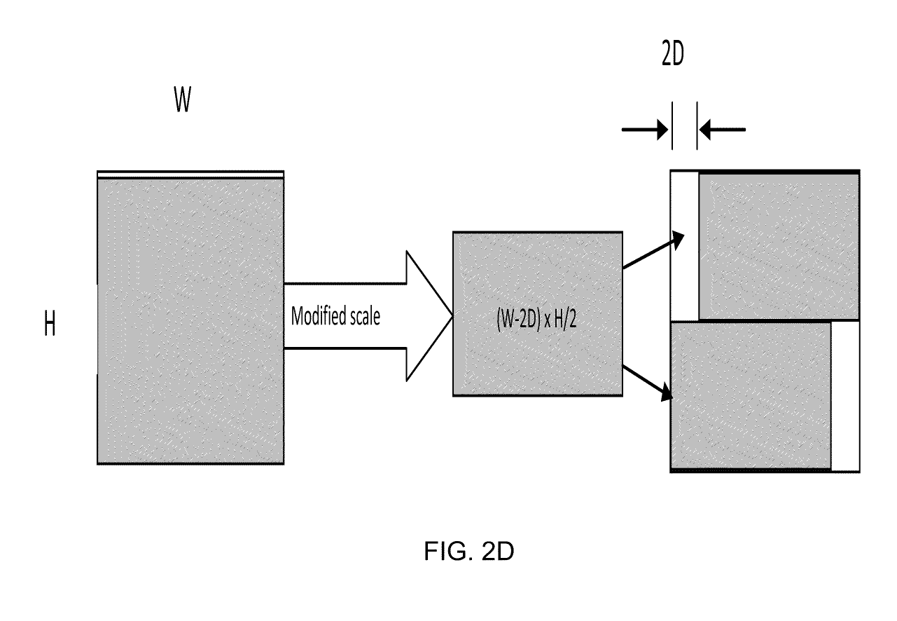

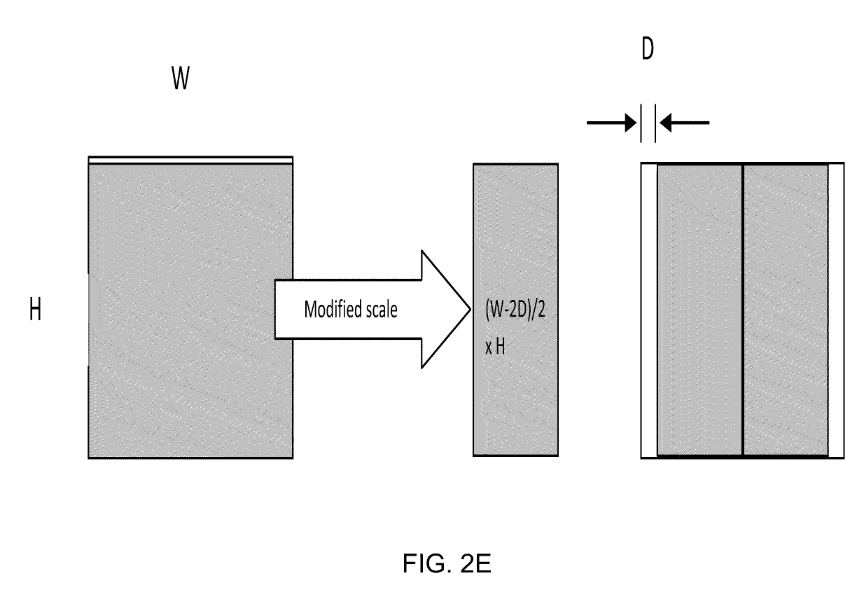

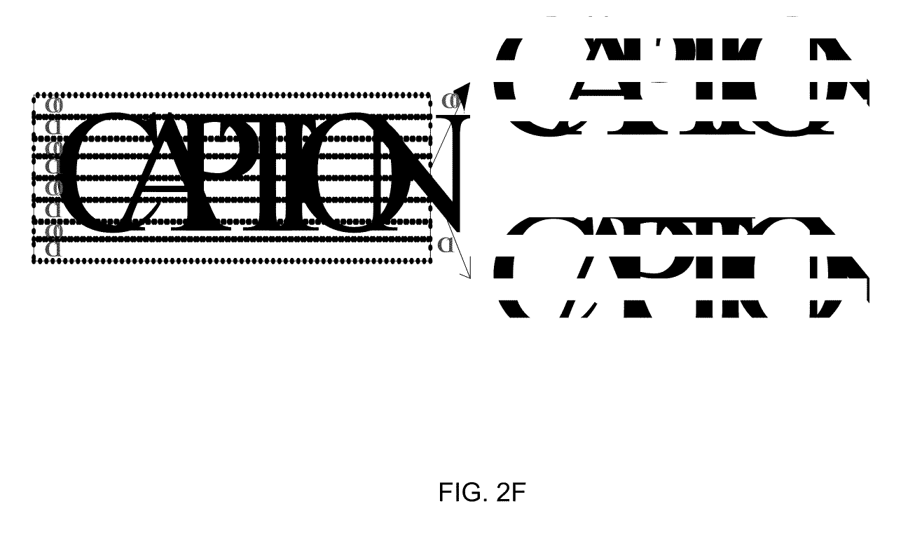

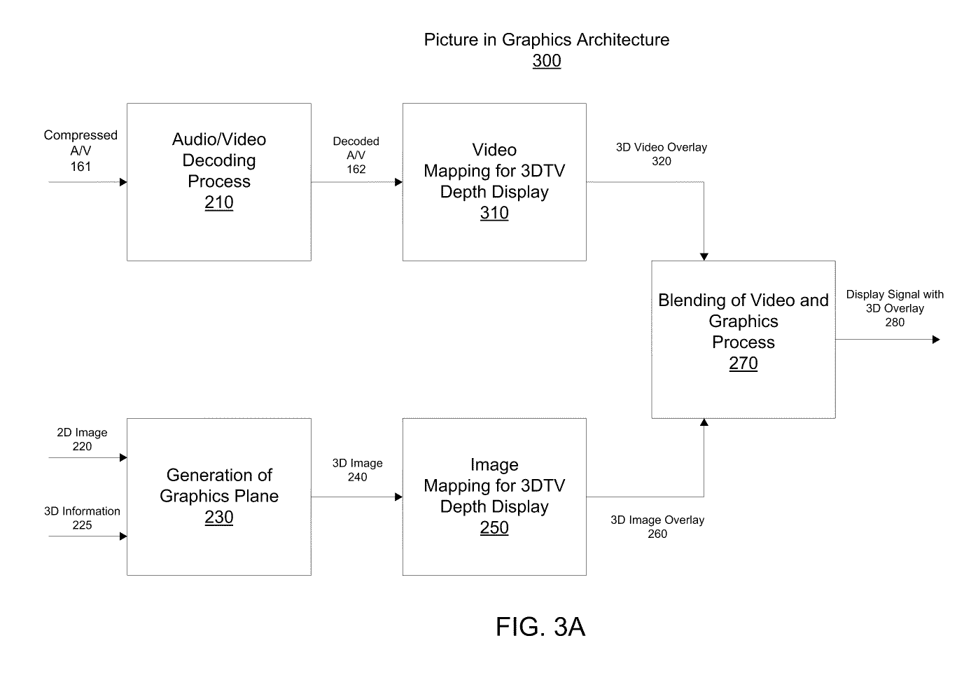

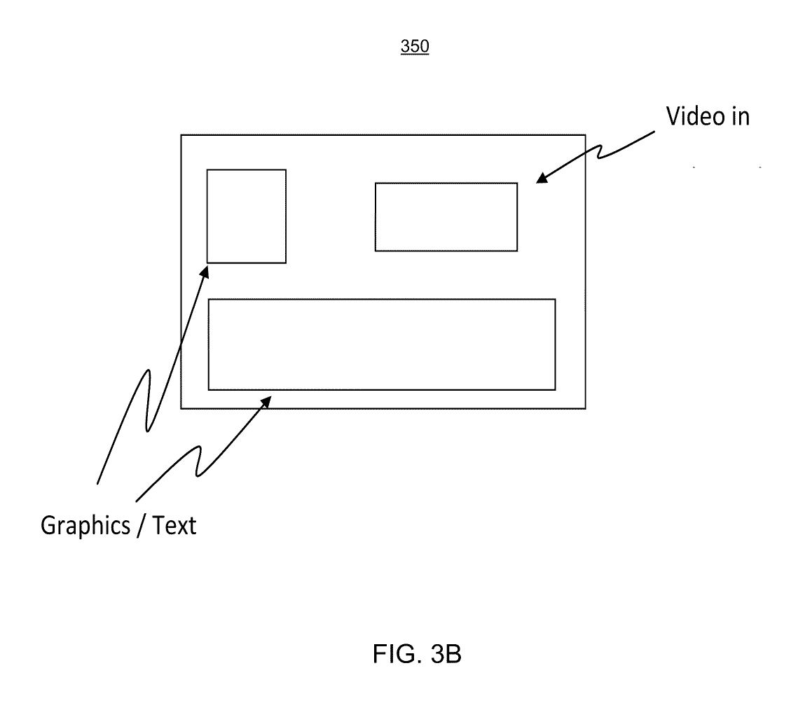

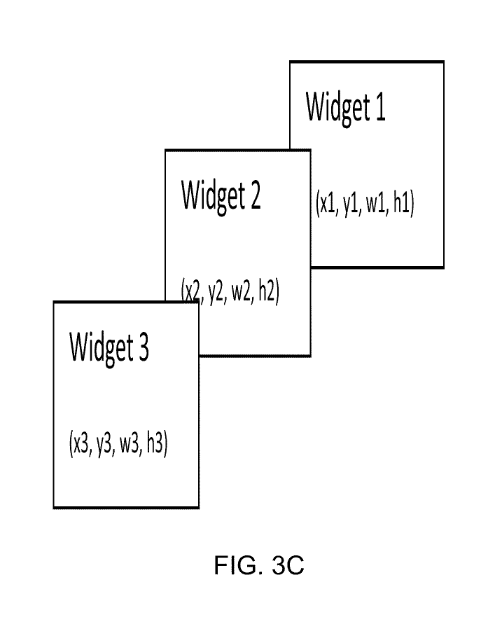

The present disclosure demonstrates an apparatus to provide visual depth associated with a 3D image to a 2D graphical image utilized in an overlay for 3D video display. Referring to FIG. 1, there is shown a simplified block diagram of an apparatus 100, shown as a decoding apparatus, such as a set top box. The apparatus 100 is operable to implement a 3D overlay architecture, such as a 3D graphics overlay architecture 200 in shown FIG. 2A or a 3D picture in graphics architecture 300 shown in FIG. 3A. The apparatus 100 is explained in greater detail below.

To provide visual depth to a 2D graphical object, the 3D graphics overlay architecture 200 provides for an offset between two reproductions of a 2D graphical object which is to be converted for a 3D graphics overlay. A 2D object is first copied into two locations and then an offset or shift may be introduced between the two copies. A process of scaling and copying 290 is demonstrated in FIG. 2B and a process of shifting 292 is demonstrated in FIG. 2C. The shift may be set at a default value and can be preconfigured by settings in the apparatus 100 or controlled based on manual user input, such as via remote control. As a general consideration, a level of 3D depth perception introduced to a 2D graphical object may be proportionally related to the degree of an offset introduced in the two reproductions of the 2D image.

The offset or shift may be horizontal or vertical. Graphics generated this way may be blended with 3D video with transparency. The transparency may also be controlled by an alpha value which may be set by the apparatus 100 or controlled by a user via remote control, if desired. Each graphical object may also be given its own separate offset so that it appears at a different 3D depth level in comparison to other objects. The level of depth may also be controlled based on the object that is selected by a user to interact or selectively controlled for an enhanced viewing experience.

FIG. 2A provides a flow diagram as an overview of a 3D graphics overlay architecture 200. In FIG. 2A, a compressed video stream, such as compressed audio/video (A/V) stream 161, is introduced to an audio/video decoding process 210. The audio/video decoding process 210 decodes the A/V stream 161 to form a decoded A/V stream 162 which may include a 3D video stream. The 3D graphics overlay 260 which is blended with decoded A/V stream 162 may be prepared as follows. A 2D image 220 is first generated. 2D image 220 may be any 2D graphical image or an object, such as an on-screen display (OSD) object, closed-captioning object or any other graphical object. The 2D image 220 is then introduced with 3D information 225 associated with the desired overlay to be produced and/or associated with the decoded A/V 162 to a process of a generation of a graphics plane 230. It is in the generation of a graphics plane 230 that the 2D image 220 is manipulated to generate a 3D image 240. The 3D image 240 may then enter a Image Mapping for 3DTV Depth Display process 250. In this process 3D image 240 is mapped to the expected frames for a 3D display. The mapped 3D image is then a 3D image overlay 260 which can be utilized in process of blending of video and graphics 270 with the frames in decoded A/V 162. Blending, in terms of video data processing, is a process which involves compositing different layers of graphics, video data and information into single frame buffer. The blended information and data may then be utilized as a 3D display signal with 3D overlay 280.

The generation of the graphics plane 230 may include the process of scaling and copying 290 demonstrated in FIG. 2B, or similar variants. For this operation, 3D information 225 is utilized. 2A. According to the 3D information 225, the generation of the graphics plane 230 generates a 3D graphics plane (e.g., side-by-side or top-bottom) as shown in FIG. 2B. In FIG. 2B, a graphics window in a frame buffer holds a 2D image, such as 2D image 220. The graphics window is then scaled down from its original dimensions. The scaling down may be to reduce the width by half, or the height by half or similar dimensioning. In FIG. 2B, the width of the graphics window is reduced by half according to the 3D information 225. Then the scaled down graphics window is reproduced so the two images, the scaled down original and its copy then occupy a similar space as the original graphics window in the frame buffer.

The generation of the graphics plane 230 may also include the process of offsetting 292 demonstrated in FIG. 2C, or similar variants. In FIG. 2C, the two halves shown are in horizontal alignment with a left view on top and a right view on the bottom. As shown in FIG. 2C, the two halves are shifted to introduce an offset for depth perception.

As used herein the terms squeeze and scale can be described as follows. Referring to FIG. 2C, a squeeze in the picture, means the left view picture and right view picture are squeezed into the top-bottom format or side-by-side format, but they are not limited to these. For example, in top-bottom format squeezing a left/right view picture vertically from original height H into a squeezed height h/2. Referring to FIG. 2D, in a side-by-side format, the picture is squeezed horizontally from original width W into squeezed width w/2. Scale may be used to address how depth is introduced and may apply to a horizontal direction.

Shift and crop is a process which may be utilized in the generation of the graphics plane 230. Referring to FIG. 2C in Top-bottom format, first shift left view in the top and right view in the bottom in the opposite direction by disparity D, respectively. Because of shifting operation, right/left boundary of left/right view is out of the frame shown in TV screen and cropped. Similarly, left/right boundary of left/right view has no video and filled by black pixels. Because of shift and crop, there is a loss of right/left boundary information.

Shift and Scale is also a process which may be utilized in the generation of the graphics plane 230. Referring to FIG. 2D in Top-bottom format, first shift left view in the top and right view in the bottom in the opposite direction by disparity 2D, respectively. Instead of crop the right/left boundary of left/right view in “shift and crop”, left and right view is scaled down to the width of “(W-2D)” from original width “W”. Left/right boundary of left/right view has no video and filled by black pixels. By this operation, it is possible to maintain all the frame information within video frame.

Shift, Crop and Scale is also a process which may be utilized in the generation of the graphics plane 230. Referring to FIG. 2C again in top-bottom format, first shift left view in the top and right view in the bottom in the opposite direction by disparity D, respectively. Because of shifting operation, right/left boundary of left/right view is out of the frame shown in TV screen and cropped. Instead of filling left/right boundary of left/right view by black pixels, then up-scale left/right view of size (W-D) into W to fill the gap. Although there is a loss of the information, there is not an incurring of black borders in the video frame, which may be irritating for 3D perception.

In a 3D panel format, graphics may be squeezed and repeated in each panel with the disparity. One way to squeeze the graphics is to simply drop every other line. Another way to squeeze the graphics is to filter it to avoid aliasing after the reduction in size. Another method of squeezing the resolution is performed such that the original graphics is de-interleaved horizontally or vertically according to the 3D panel format and each field can be placed in the proper panel.

FIG. 2F demonstrates a process of de-interleaving 294. In FIG. 2F, an example of de-interleaving of a caption is shown for top-bottom format. C0 and C1 fields are de-interleaved and separated. Squeezed captions are then placed in the top/bottom or bottom/top according to the 3D TV display format. When the 3D image based on C0 and C1 is converted into 3D mode, the perceived resolution of graphics could be improved with respect to repeated captions in both top and bottom planes.

FIG. 3A provides a flow diagram of a picture in graphics architecture 300 which is similar image overlay architecture 200 in the flow diagram in FIG. 2A. However, FIG. 3A introduces the Video Mapping for 3DTV Depth Display process 310 in which video data in the decoded A/V 162 is also mapped as a 3D picture in graphics 320. This may be blended as described above with the other elements as described above with respect to FIG. 2A. A 2D image 220 is first generated. 2D image 220 may be any 2D graphical image or an object, such as an on-screen display (OSD) object, closed-captioning object or any other graphical object. The 2D image 220 is then introduced with 3D information 225 associated with the desired overlay to be produced and/or associated with the decoded A/V 162 to a process of a generation of a graphics plane 230.

It is in the generation of a graphics plane 230 that the 2D image 220 is manipulated to generate a 3D image 240. The picture in graphics architecture 300 is now explained with respect to a program guide display 350 in FIG. 3B. A program guide display, such as program guide display 350, may include a video playing back in a sub-video window such as a picture in picture (PIP) as shown in FIG. 3B. In this case, video also needs to be processed to display program guide display 350 on a 3DTV display. The video may be 2D or 3D video in top-bottom or side-by-side format. When the video is 2D, both graphics and video in the “video in” window may be squeezed/scaled and copied in two locations, horizontally or vertically depending upon the top-bottom or side-by-side 3D format. An offset to the scaled video may also be added to make it appear inside or outside the TV. An offset for each graphics objects and video may be the same or different.

If the video is delivered in 3D format, it may be (1) 3D video which consists of the same panel format as 3D TV display, for example both allowing top-bottom format, or (2) 3D video and the 3D TV display using different formats, for example, the 3D video could be in top-bottom format and display may accept only side by side format.

In the first case, the video is cut in two halves at the boundary of the two eye views and displayed in a corresponding half after compositing it with a scaled down graphics as described above. For example, if 3D video is in side by side format, then the video corresponding to the sub-window is cut vertically and left half is composited with the graphics corresponding to the left half and the right half is composited with the graphics corresponding to the right half.

In the second case, the video format is converted after the breaking it in two half. For example, it the video in top-bottom format and the display is in side by side format then after cutting it in two top-bottom halves, each half is converted to the left half of the side by side format by scaling it down horizontally and interpolating it up vertically and then composited with the corresponding side of the graphics. In another method, if video is in 3D panel format, the receiver may simply scale down the combined video or show as is and copy in the two halves as done for graphics.

Graphics for display in the 3D image overlay may be assigned a priority, or Z-order, according to the apparatus 100 setting or user preference. A modified graphics library may pass an objects Z-order and other information to 3D mapping engine. Then a depth map is generated based on received information. The created z value is only limited by the maximum depth set in the system. For example, Z values can be uniformly distributed based on the number of the objects aligned in Z axis. In this case, each graphics objects can be provided independent depth by the 3D mapping engine. In applying the same procedures as described above for either top-bottom or side-by-side 3D format to provide, if desired, different depth for each object. The mapping operations may be iterated in the order of the window's position in Z axis by starting from the graphic window with the maximum Z value, and ending with the window with the minimum Z value. All iterations may be applied to a same frame buffer.

For the graphics with multiple objects with Z-order specified by the graphics engine, an additional step as described below can be applied. In this case, the user interface may consist of layers of windows, widgets and other graphic objects in Z-order. To enable 3D TV with depth based user experience on these Z-order graphics, one example allows a user to also include the following steps, if desired by the user. In the first step, a Z-order information on graphics is retrieved. This is followed by a depth map creation. Based on the Z-order, origin and size of the retrieved graphic windows, a depth map will then be created.

Referring to FIG. 3C, this figure shows one example of windows in Z-axis. First, a modified graphics library will pass widget's Z-order and other information to a 3D mapping engine. Then a depth map is generated based on received information. In the example of FIG. 3C, the depth map will be (x1, y1, z1, w1, h1) (x2, y2, z2, w2, h2) (x3, y3, z3, w3, h3) with z1>z2>z3. Note that the created z value is limited by the maximum depth set in the system. For example, Z values can be uniformly distributed based on the number of the objects aligned in Z axis.

Now mapping graphics with the depth map is described. In this case, each graphics objects can be provided independent depth by the 3D mapping engine. The same procedures as described above are applied for either top-bottom or side-by-side 3D format to provide, if desired, different depth for each object. This is iterated in the mapping operations in the order of the window's position in Z axis by starting from the graphic window with the maximum Z value, and ending with the window with the minimum Z value. Note that all iterations will be applied to the same frame buffer.

FIG. 1 illustrates the apparatus 100, according to an example, in which the apparatus 100 is an integrated receiving device (IRD) or a set top box (STB). The apparatus 100 includes a receiver buffer 110, a decoding unit 120, a frame memory 130, a processor 140 and a storage device 150. The apparatus 100 receives a transport stream 105 with compressed video data, which includes compressed A/V 161 described above with respect to FIG. 3A. The transport stream 105 is not limited to any specific video compression standard. The processor 140 of the apparatus 100 controls the amount of data to be transmitted on the basis of the capacity of the receiver buffer 110 and may include other parameters such as the amount of data per a unit of time. The processor 140 controls the decoding unit 120, to prevent the occurrence of a failure of a received signal decoding operation of the apparatus 100. The processor 140 may include, for example, a microcomputer having a separate processor, a random access memory and a read only memory.

The transport stream 105 is supplied from, for example, a headend facility. The transport stream 104 includes stereoscopic video signal data. The stereoscopic video signal data may include pictures and/or frames which are decoded at the apparatus 100. The receiver buffer 110 of the apparatus 100 may temporarily store the encoded data received from the headend facility via the transport stream 105. The apparatus 100 counts the number of coded units of the received data, and outputs a picture or frame number signal 163 which is applied through the processor 140. The processor 140 supervises the counted number of frames at a predetermined interval, for instance, each time the decoding unit 120 completes the decoding operation.

When the picture/frame number signal 163 indicates the receiver buffer 110 is at a predetermined capacity, the processor 140 outputs a decoding start signal 164 to the decoding unit 120. When the frame number signal 163 indicates the receiver buffer 110 is at less than a predetermined capacity, the processor 140 waits for the occurrence of the situation in which the counted number of pictures/frames becomes equivalent to the predetermined amount. When the picture/frame number signal 163 indicates the receiver buffer 110 is at the predetermined capacity, the processor 140 outputs the decoding start signal 164. The encoded units may be decoded in a monotonic order (i.e., increasing or decreasing) based on a presentation time stamp (PTS) in a header of the encoded units.

In response to the decoding start signal 164, the decoding unit 120 decodes data amounting to one picture/frame from the receiver buffer 110, and outputs the data. The decoding unit 120 writes a decoded signal 162 into the frame memory 130. The frame memory 130 has a first area into which the decoded signal is written, and a second area used for reading out the decoded data and outputting it to a display for a 3DTV or the like.

Disclosed herein are methods and an apparatus for preparing a three dimensional (3D) video graphical overlay in a decoded stereoscopic video signal. With reference first to FIG. 1, there is shown a simplified block diagram of an IRD or STB apparatus 100, according to an example. It is apparent to those of ordinary skill in the art that the diagram of FIG. 1 represents a generalized illustration and that other components may be added or existing components may be removed, modified or rearranged without departing from the scope of the apparatus 100.

The IRD or STB apparatus 100 is depicted as including, as subunits 110-150, the receiver buffer 110, the decoding unit 120, the frame memory 130, the processor 140 and the storage device 150. The subunits 110-150 may comprise MRIS code modules, hardware modules, or a combination of MRISs and hardware modules. Thus, in one example, the subunits 110-150 may comprise circuit components. In another example, the subunits 110-150 may comprise code stored on a computer readable storage medium, which the processor 140 is to execute. As such, in one example, the apparatus 100 comprises a hardware device, such as, a computer, a server, a circuit, etc. In another example, the apparatus 100 comprises a computer readable storage medium upon which MRIS code for performing the functions of the subunits 110-150 is stored. The various functions that the apparatus 100 performs are discussed in greater detail below.

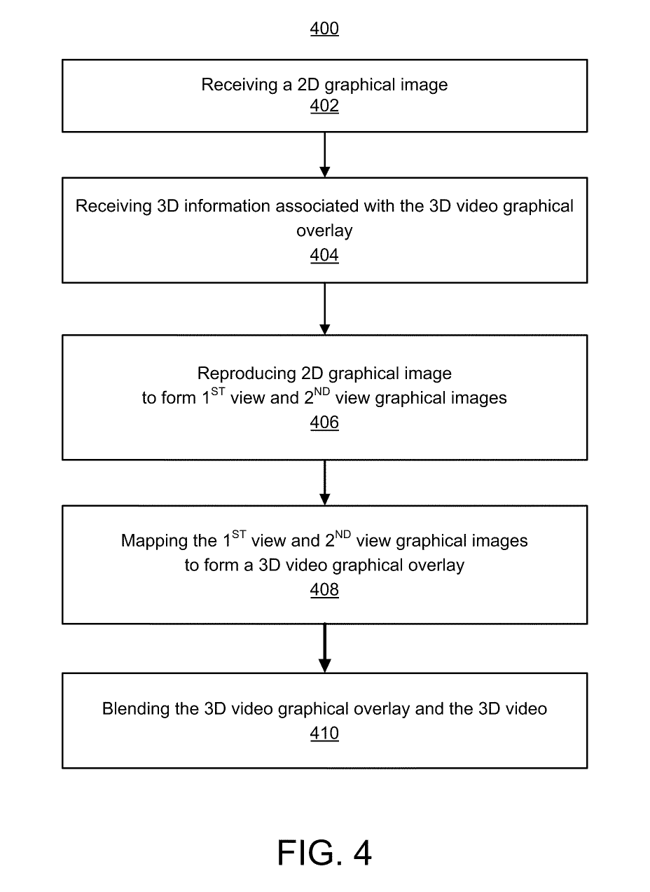

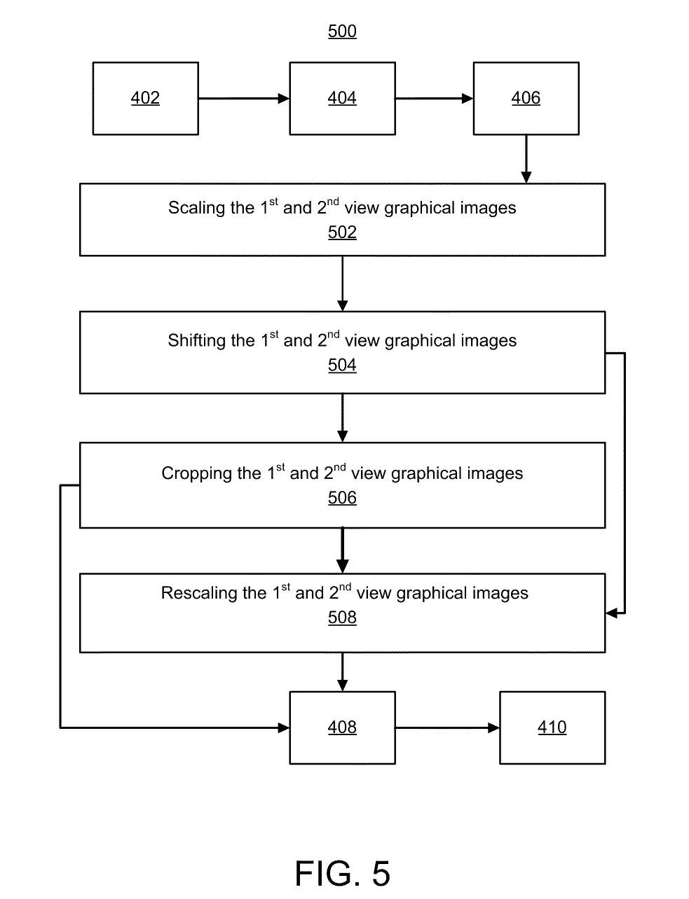

According to an example, the IRD or STB apparatus 100 is to implement methods of preparing a three dimensional (3D) video graphical overlay in a decoded stereoscopic video signal. Various manners in which the subunits 110-150 of the apparatus 100 may be implemented are described in greater detail with respect to FIGS. 4 and 5, which depict flow diagrams of methods 400 and 500 to perform methods of preparing a three dimensional (3D) video graphical overlay in a decoded stereoscopic video signal.

It is apparent to those of ordinary skill in the art that the methods 400 and 500 represent generalized illustrations and that other blocks may be added or existing blocks may be removed, modified or rearranged without departing from the scopes of the methods 400 and 500.

The descriptions of the methods 400 and 500 are made with particular reference to the apparatus 100 depicted in FIG. 1 and the architectures 200 and 300 depicted in FIGS. 2A and 3A. It should, however, be understood that the methods 400 and 500 may be implemented in an apparatus that differs from the apparatus 100 and the architectures 200 and 300 without departing from the scopes of the methods 400 and 500.

With reference first to the method 400 in FIG. 4, at block 402, receiving a 2D graphical image is performed utilizing the frame memory 130. With reference to the method 500 in FIG. 5, block 402, is referenced as part of method 500 reproduced as block 402 in method 500.

Block 404, receiving 3D information associated with the 3D video graphical overlay, may be implemented utilizing the frame memory 113 and/or the processor 140. With reference to the method 500 in FIG. 5, block 404, is referenced as part of method 500 reproduced as block 404 in method 500.

Block 406, in FIG. 4, reproducing a 2D graphical image to form first view and second view graphical images in a graphics window, may be implemented with the processor 140. With reference to the method 500 in FIG. 5, block 406, is referenced as part of method 500 reproduced as block 406 in method 500.

Block 408, in FIG. 4, mapping the first view and second view graphical images to form a 3D video graphical overlay, may be implemented utilizing the processor 140. With reference to the method 500 in FIG. 5, block 408, is referenced as part of method 500 reproduced as block 408 in method 500.

Block 410, in FIG. 4, blending the first view and second view graphical images to form a 3D video graphical overlay, may be implemented utilizing the processor 140. This is the final block in method 400. With reference to the method 500 in FIG. 5, block 410, is referenced as part of method 500 reproduced as block 410 in method 500.

Blocks 402 to 406 are separated from blocks 408 to 410, in FIG. 5, according to example of the present disclosure in method 500. In method 500, the processes in blocks 402 to 404 correspond with the same processes in these blocks in method 400 shown in FIG. 4.

Block 502, in FIG. 5, scaling the first view and second view graphical images, may be implemented utilizing the processor 140. In block 502, the first view and second view graphical images have been reproduced from the 2D graphical image received in block 402.

Block 504, in FIG. 5, shifting the first view and second view graphical images, may be implemented utilizing the processor 140.

Block 506, in FIG. 5, cropping the first view and second view graphical images, may be implemented utilizing the processor 140. As shown in FIG. 5, according to an example of the present disclosure, block 506 may be bypassed in an example in which block 508 immediately follows block 504.

Block 508, in FIG. 5, rescaling the first view and second view graphical images, may be implemented utilizing the processor 140. As shown in FIG. 5, according to an example of the present disclosure, block 508 may be bypassed in an example in which block 408 immediately follows block 504.

Blocks 408 and 410 are separated from blocks 402 to 406, in FIG. 5, according to example of the present disclosure in method 500. In method 500, the processes in blocks 408 and 410 correspond with the same processes in these blocks in method 400 shown in FIG. 4.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as MRIS program(s) comprised of program instructions in source code, object code, executable code or other formats. Any of the above may be embodied on a computer readable storage medium, which include storage devices.

An example of a computer readable storage media includes a conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

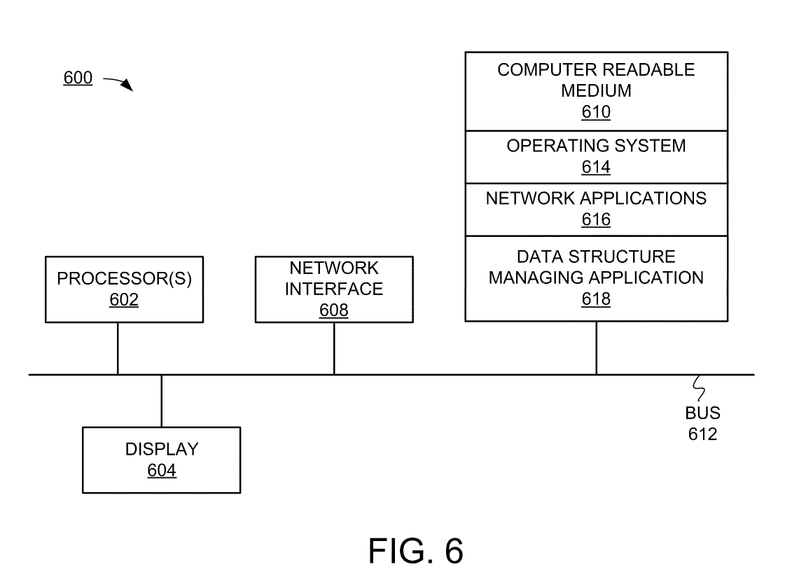

Turning now to FIG. 6, there is shown a computing device 600, which may be employed as a platform for implementing or executing the methods depicted in FIGS. 4 and 5, or code associated with the methods. It is understood that the illustration of the computing device 600 is a generalized illustration and that the computing device 600 may include additional components and that some of the components described may be removed and/or modified without departing from a scope of the computing device 600.

The device 600 includes a processor 602, such as a central processing unit; a display device 604, such as a monitor; a network interface 608, such as a Local Area Network (LAN), a wireless 802.11x LAN, a 3G or 4G mobile WAN or a WiMax WAN; and a computer-readable medium 610. Each of these components may be operatively coupled to a bus 612. For example, the bus 612 may be an EISA, a PCI, a USB, a FireWire, a NuBus, or a PDS.

The computer readable medium 610 may be any suitable medium that participates in providing instructions to the processor 602 for execution. For example, the computer readable medium 610 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 610 may also store other MRIS applications, including word processors, browsers, email, instant messaging, media players, and telephony MRIS.

The computer-readable medium 610 may also store an operating system 614, such as MAC OS, MS WINDOWS, UNIX, or LINUX; network applications 616; and a data structure managing application 618. The operating system 614 may be multi-user, multiprocessing, multitasking, multithreading, real-time and the like. The operating system 614 may also perform basic tasks such as recognizing input from input devices, such as a keyboard or a keypad; sending output to the display 604 and the design tool 606; keeping track of files and directories on medium 610; controlling peripheral devices, such as disk drives, printers, image capture device; and managing traffic on the bus 612. The network applications 616 includes various components for establishing and maintaining network connections, such as MRIS for implementing communication protocols including TCP/IP, HTTP, Ethernet, USB, and FireWire.

The data structure managing application 618 provides various MRIS components for building/updating a CRS architecture, such as CRS architecture 600, for a non-volatile memory, as described above. In certain examples, some or all of the processes performed by the application 618 may be integrated into the operating system 614. In certain examples, the processes may be at least partially implemented in digital electronic circuitry, in computer hardware, firmware, MRIS, or in any combination thereof.

Disclosed herein are methods, apparatuses and computer-readable mediums for preparing and mapping 3D graphical images, including objects and/or video as a 3D graphical overlay for 3D video, such as appears in 3DTV. The disclosure presents a solution for processing and displaying the 3D graphical images without requiring any additional meta-data information to be packaged in the compressed 3D video stream. Hence a 3D graphical overlay 3D video may be implemented in set top boxes, integrated receiving devices or other devices associated with receiving a 3D video signal.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A method of preparing a three dimensional (3D) video graphical overlay based on a two dimensional (2D) graphical image in a decoded stereoscopic video signal, the method comprising:
receiving the 2D graphical image;
receiving 3D information associated with the 3D video graphical overlay;
reproducing, using a processor, the 2D graphical image to form a first view graphical image and a second view graphical image in a graphics window;
mapping the first and second view graphical images, using the 3D information, to frames in a 3D video stream to form a 3D video graphical overlay of the 3D video stream; and
blending the 3D video graphical overlay and the 3D video stream.

2. The method of claim 1, the method further comprising:
scaling the first and second view graphical images.

3. The method of claim 1, the method further comprising:
shifting the first and second view graphical images.

4. The method of claim 1, the method further comprising:
cropping the first and second view graphical images.

5. The method of claim 1, the method further comprising:
rescaling the first and second view graphical images.

6. The method of claim 1, wherein the first and second view graphical images are placed in separate up and down horizontal panels of the graphics window.

7. The method of claim 1, wherein the first and second view graphical images are placed in separate left and right vertical panels of the graphics window.

8. The method of claim 1, wherein the 2D graphical image is de-interleaved to reproduce the first and second view graphical images.

9. The method of claim 1, wherein the 2D graphical image is a 2D object.

10. The method of claim 1, wherein the 2D graphical image is a 2D video frame.

11. The method of claim 1, wherein preparing the 3D video graphical overlay includes specifying a Z-order display priority for utilization in a user interface of a 3D video display.

12. A non-transitory computer readable medium storing computer readable instructions that when executed by a computer system perform a method of preparing a three dimensional (3D) video graphical overlay based on a two dimensional (2D) graphical image in a decoded stereoscopic video signal, the method comprising:
receiving the 2D graphical image;
receiving 3D information associated with the 3D video graphical overlay;
reproducing, using a processor, the 2D graphical image to form a first view graphical image and a second view graphical image in a graphics window;
mapping the first and second view graphical images, using the 3D information, to frames in a 3D video stream to form a 3D video graphical overlay of the 3D video stream; and
blending the 3D video graphical overlay and the 3D video stream.

13. The computer readable medium of claim 12, the method further comprising:
scaling the first and second view graphical images.

14. The computer readable medium of claim 12, the method further comprising:
shifting the first and second view graphical images.

15. The computer readable medium of claim 12, the method further comprising:
cropping the first and second view graphical images.

16. The computer readable medium of claim 12, the method further comprising:
rescaling the first and second view graphical images.

17. The computer readable medium of claim 12, wherein the first and second view graphical images are placed in separate up and down horizontal panels of the graphics window.

18. The computer readable medium of claim 12, wherein the first and second view graphical images are placed in separate left and right vertical panels of the graphics window.

19. The computer readable medium of claim 12, wherein the 2D graphical image is de-interleaved to reproduce the first and second view graphical images.

20. The computer readable medium of claim 12, wherein the 2D graphical image is a 2D object.

21. The computer readable medium of claim 12, wherein the 2D graphical image is a 2D video frame.

22. The computer readable medium of claim 12, wherein preparing the 3D video graphical overlay includes specifying a Z-order display priority for utilization in a user interface of a 3D video display.

23. An apparatus to prepare a three dimensional (3D) video graphical overlay based on a two dimensional (2D) graphical image in a decoded stereoscopic video signal, the apparatus comprising:
a processor to
receive the 2D graphical image;
receive 3D information associated with the 3D video graphical overlay;
reproduce, using a processor, the 2D graphical image to form a first view graphical image and a second view graphical image in a graphics window;
map the first and second view graphical images, using the 3D information, to frames in a 3D video stream to form a 3D video graphical overlay of the 3D video stream; and
blend the 3D video graphical overlay and the 3D video stream.

24. The apparatus of claim 23, wherein the processor is to scale the first and second view graphical images.

25. The apparatus of claim 23, wherein the processor is to shift the first and second view graphical images.

26. The apparatus of claim 23, wherein the processor is to crop the first and second view graphical images.

27. The apparatus of claim 23, wherein the processor is to rescale the first and second view graphical images.

28. The apparatus of claim 23, wherein the first and second view graphical images are placed in separate up and down horizontal panels of the graphics window.

29. The apparatus of claim 23, wherein the first and second view graphical images are placed in separate left and right vertical panels of the graphics window.

30. The apparatus of claim 23, wherein the 2D graphical image is de-interleaved to reproduce the first and second view graphical images.

31. The apparatus of claim 23, wherein the 2D graphical image is a 2D object.

32. The apparatus of claim 23, wherein the 2D graphical image is a 2D video frame.

33. The apparatus of claim 23, wherein preparing the 3D video graphical overlay includes specifying a Z-order display priority for utilization in a user interface of a 3D video display.
